(19) United States
(12) Patent Application Publication
(10) Pub. No.: US 2025/0374949 A1
(43) Pub. Date: Dec. 11, 2025

(54) COOLING ASSEMBLY FOR ROASTED PLANT-BASED BULK MATERIAL, ROASTING ASSEMBLY AND METHOD FOR OPERATING A ROASTING ASSEMBLY

(71) Applicant: PROBAT SE, EMMERICH (DE)

(72) Inventors: PETER HAINKE, HAMMINKELN-DINGDEN (DE); THOMAS KOZIOROWSKI, MUELHEIM AN DER RUHR (DE)

(73) Assignee: PROBAT SE, EMMERICH (DE)

(21) Appl. No.: 18/874,094

(22) PCT Filed: Jun. 29, 2023
(86) PCT No.: PCT/EP2023/067762

§ 371 Date: Dec. 12, 2024

(30) Foreign Application Priority Data
Jun. 29, 2022 (DE) 10 2022 116 191.9

(51) Int. Cl. A23N 12/12; A23N 12/08; F24C 15/20; F24C 15/36; G01J 5/00; G01J 5/08; G01J 5/48

(52) U.S. Cl. CPC A23N 12/125; A23N 12/086; F24C 15/20; F24C 15/36; G01J 5/0859; G01J 5/48; G01J 2005/0077

(57) ABSTRACT

A cooling arrangement for a roasted vegetable bulk material. The cooling arrangement includes a cooling chamber for cooling the roasted vegetable bulk material. The cooling chamber has a bulk material receiving surface and a sensor arrangement having at least one temperature sensor which monitors a temperature of the roasted vegetable bulk material.

### CROSS REFERENCE TO PRIOR APPLICATIONS

This application is a U.S. National Phase application under 35 U.S.C. § 371 of International Application No. PCT/EP2023/067762, filed on Jun. 29, 2023 and which claims benefit to German Patent Application No. 10 2022 116 191.9, filed on Jun. 29, 2022. The International Application was published in German on Jan. 4, 2024 as WO 2024/003210 A1 under PCT Article 21 (2).

### FIELD

The present invention relates to a cooling arrangement for roasted vegetable bulk material, the cooling arrangement having a cooling chamber for cooling the roasted vegetable bulk material, wherein a bulk material receiving surface is configured in the cooling chamber. The present invention also relates to a roasting arrangement and to a method for operating the roasting arrangement.

### BACKGROUND

Cooling arrangements, as well as roasting arrangements with such cooling arrangements, are well known from the prior art. For example, DE 297 17 010 U1 describes a cooling arrangement for roasted coffee beans, cocoa or nuts where air is passed through a circular, rotatably mounted cooling sieve upon which the bulk material is stored in order to cool the bulk material. The cooling chamber is in this case provided in the region of a roasting device and passes from the roasting device into the cooling chamber via centrifugal force after the roasting process is completed.

It is known that, due to the roasting process, hot spots are generated in the roasted vegetable bulk material which pass into the cooling chamber of the cooling arrangement after completion of the roasting process. In the least critical case, such glowing hot spots affect the quality of the respective roasted batch of the vegetable bulk material that has just been roasted. In the worst case, such glowing hot spots can cause the cooling system or a downstream unit to catch fire.

### SUMMARY

An aspect of the present invention is to avoid the above-mentioned disadvantages in a simple and cost-effective way.

In an embodiment, the present invention provides a cooling arrangement for a roasted vegetable bulk material. The cooling arrangement includes a cooling chamber for cooling the roasted vegetable bulk material. The cooling chamber comprises a bulk material receiving surface and a sensor arrangement comprising at least one temperature sensor which is configured to monitor a temperature of the roasted vegetable bulk material.

### BRIEF DESCRIPTION OF THE DRAWINGS

The present invention is described in greater detail below on the basis of embodiments and of the drawings in which:

FIG. 1 shows a schematic representation of a roasting arrangement according to the present invention;

FIG. 2 shows a detailed view of a hood arrangement of a cooling arrangement according to the present invention; and

FIG. 3 shows a detailed view of a sensor arrangement arranged in the hood arrangement of FIG. 2.

### DETAILED DESCRIPTION

The present invention provides a cooling arrangement which has a sensor arrangement with at least one temperature sensor for monitoring the temperature of the roasted vegetable bulk material in the cooling chamber. This allows a local overheating, which has a temperature above a predetermined limit temperature, to be detected in a particularly simple manner. By so detecting a local overheating at an early stage, suitable countermeasures can be applied depending on the degree of the local overheating. It is also possible to separate the entire roasted batch of a roasted vegetable bulk material or only a part thereof in order to provide a uniformly high quality of the roasting process for a customer.

The at least one temperature sensor can, for example, be a thermographic camera, which makes it possible to record video images of the roasted vegetable bulk material in the cooling chamber and to archive the video images if necessary. To provide proper and, for example, maintenance-free monitoring of the bulk material receiving surface, the thermographic camera can, for example, comprise a purge air device. The purging/flushing air is thereby directed laterally over the camera lens where the air acts as an air curtain. It can be advantageous to provide a protective spacer sleeve in front of the camera lens of the thermographic camera to generate a cylindrical piston flushing air flow.

A hood arrangement can, for example, be provided above the bulk material receiving surface in which the at least one temperature sensor is integrated. The hood arrangement in this case defines the cooling space and makes it possible to extract the cooling air together with any contamination in a controlled manner. The hood arrangement also provides a particularly simple mounting option for the at least one temperature sensor. In the embodiment where the temperature sensor is provided as a thermographic camera, the thermographic camera can, for example, be arranged on the side of the hood arrangement facing away from the cooling device, wherein the protective spacer sleeve extends into the cooling chamber.

A control device can, for example, be provided to monitor the cooling process. A control device of this kind serves to send alarm signals or, if necessary, to stop a roasting process that has already begun. It can thereby be advantageous for the control device of the cooling arrangement to be integrated into a control device of a co-operating roasting arrangement.

The cooling chamber can, for example, comprise a cooling sieve for receiving the roasted vegetable bulk material and for passing cold air. The cooling sieve can provide a sufficiently large bulk material receiving surface that can easily be monitored by at least one temperature sensor.

The cooling arrangement can, for example, comprise a circulating device with a tangential basic direction for the roasted vegetable bulk material. Such a circulating device can be configured in different ways. If a cooling sieve is present, the roasted vegetable bulk material can be circulated through a cooling sieve that is set in rotation by a driving device. It is also conceivable that a shovel device is provided as a part of the circulation device for circulating the roasted vegetable bulk material. Due to the continuous circulation of the bulk material in a tangential direction, the temperature sensor can be configured so that only a partial area of the bulk material receiving surface is detected. The entire bulk material is guided through this partial area during a cooling process via the circulation. It is also conceivable, however, that the bulk material is not actively moved and only rests on the cooling screen with cooling air flowing therethrough.

The temperature sensor can alternatively or additionally be movably supported and

can be driven by a drive device so that different partial areas of the bulk material receiving surface can respectively be detected.

The present invention also provides a roasting arrangement for vegetable bulk material with the described cooling arrangement, wherein a housing arrangement is provided which has at least one roasting device, a heating device for heating an interior space of the roasting device, an exhaust gas cleaning device for removing exhaust gases from the roasting device, and a control device for monitoring a cooling process, wherein the cooling arrangement is provided in the region of at least one outlet opening of the roasting device.

The present invention also provides a method for operating the roasting arrangement wherein, after the roasting process has been completed, the roasted vegetable bulk material is passed into the cooling arrangement so that a bulk material surface of the roasted vegetable bulk material is configured, wherein this bulk material surface is monitored by at least one temperature sensor and a signal is output by the control device in the event of a local overheating. In order to avoid misinterpretations, different temperature limits can be set for different cooling durations. It is in this case particularly advantageous if a thermographic camera is provided, wherein a cooling process is created in a data storage or a database by the control device after each completion of the roasting process and a video of the thermographic camera is associated with the cooling process, wherein the video is stored and the cooling process is marked if a pre-set temperature limit is exceeded. Batches can thereby be recorded very easily, in particular with regard to quality control, which may not meet the desired quality standard due to overheating. The marking can here be carried out, for example, via different priorities, wherein at least a first and a second priority stage are provided. If the temperature thereby exceeds the temperature limit for a longer period, an alarm can, for example, be triggered that requires a check of the roasting arrangement and the cooling arrangement. If the temperature limit is exceeded, but only for a very short time, this message can simply be stored as information since it may be caused, for example, by the cooling sieve being dirty.

The present invention is explained in greater detail below with reference to the drawings.

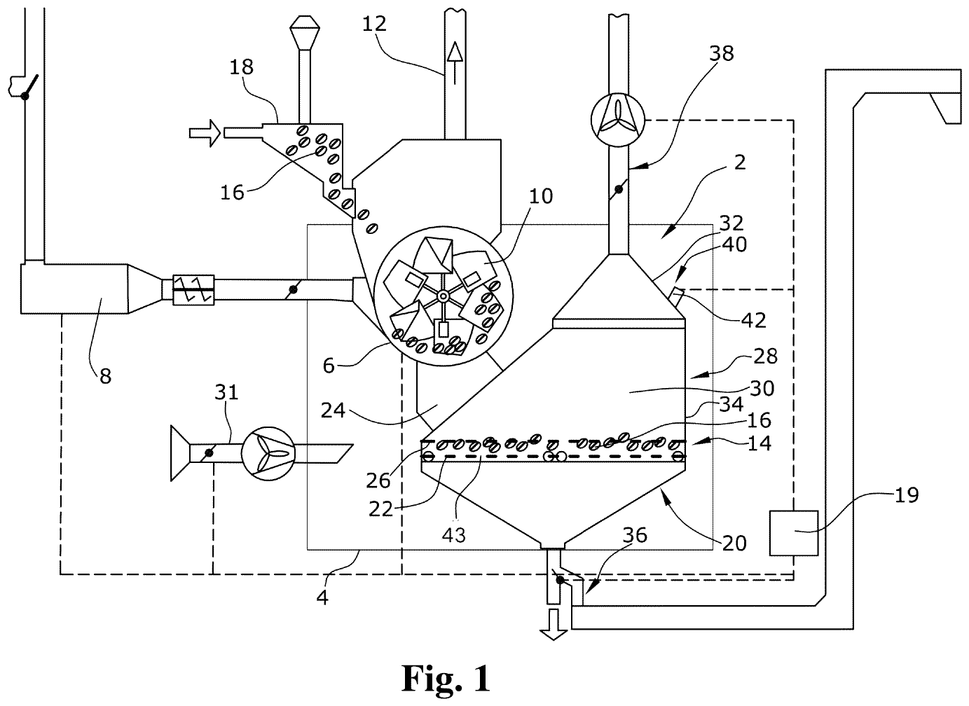

FIG. 1 shows a schematic representation of a roasting arrangement 2 according to the present invention which is well known per se from the prior art. The roasting arrangement 2 thereby comprises a housing arrangement 4, which comprises at least a roasting device 6, a heating device 8, for heating an interior space 10 of the roasting device 6, an exhaust gas cleaning device 12 for discharging exhaust gases from the interior space 10 of the roasting device 6 and, in the present embodiment, a cooling arrangement 14 for cooling a vegetable bulk material to be roasted, such as coffee beans.

The unroasted coffee beans 16 are supplied to the interior space 10 of the roasting device 6 via a hopper inlet 18. A control device 19 is also provided which controls or regulates a roasting process and a cooling process.

In the present embodiment, the cooling arrangement 14 according to the present invention consists of a cooling device 20 comprising a cooling sieve 22 that is rotatable via a drive mechanism (which is here not further described) onto which the bulk material 16, here the coffee beans, are poured through an outlet opening 24 of the roasting device 6, and thereby configure a bulk material receiving surface 26. The cooling sieve 22, together with a hood arrangement 28, encloses a cooling chamber 30 into which cooling air is blown by a cold air device 31. The hood arrangement 28 consists of a first housing part 32, which is designed as a dome part, and of a second housing part 34, which is connected to the cooling device 20 and thus defines the cooling chamber 30. A bulk material outlet arrangement 36 adjoins the cooling device 20 in a known manner and air discharge devices 38 adjoin the dome part 32, respectively. The cooling air is sucked in, is drawn through the cooling sieve 22 and the coffee beans 16 in a known manner, and is discharged via the air discharge device 38.

In order to be able to detect unwanted glowing hot spots in the bulk material 16 in a simple manner and thus to be able to provide a consistently high quality of the roasted bulk material 16 and also to be able to prevent damage to the roasting arrangement or adjacent units, the present embodiment provides a sensor arrangement 40 with a thermographic camera 42 as a temperature sensor in the dome part 32 of the hood arrangement 28 which is connected to the control device 19 via control technology. The thermographic camera 42 monitors the temperature of the roasted coffee beans by detecting the entire bulk material receiving surface 26.

Several temperature sensors 42 can alternatively be provided which respectively detect only a partial area of the bulk material receiving surface 26. The detected partial area of the bulk material receiving surface 26 can also be selected so that, when the bulk material receiving surface is rotated by a rotating device with a tangential basic direction, the entire bulk material receiving surface 26 is conveyed past the temperature sensor 42. It is also conceptually possible for the temperature sensor 42 to be movably supported and to be driven by a drive device so that different subregions of the bulk material receiving surface 26 can respectively be detected.

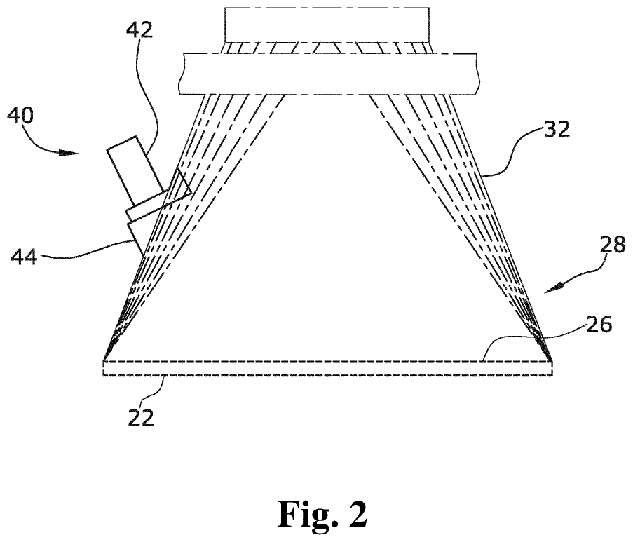

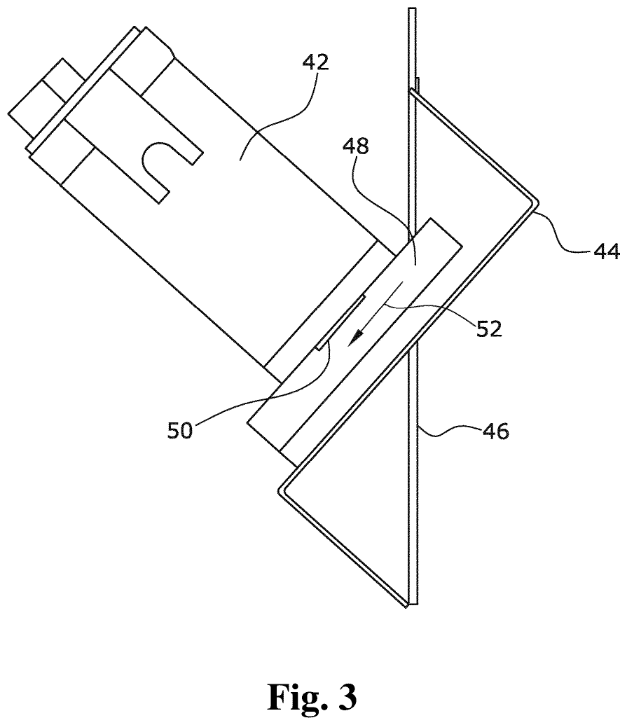

FIG. 2 shows a detailed view of the hood arrangement 28 with the mounted sensor arrangement 40. The temperature sensor 42, which is here designed as a thermographic camera, is arranged at an angle in an opening 46 of the dome part 32 via a mounting plate 44 (see in particular FIG. 3). The mounting plate 44 allows the thermographic camera 42 to be easily aligned with the bulk material receiving surface 26 to be monitored.

FIG. 3 shows a detailed view of the sensor arrangement 40 arranged in the opening 46 of the dome part 32. A schematically represented purge air device 48 is provided to protect the thermographic camera 42 and in particular a camera lens 50. The flushing air, which extends perpendicularly to the camera lens 50, is here shown via arrow 52 and acts as a curtain of flushing air.

A process for operating a roasting arrangement 2 with regard to the cooling process according to the present invention takes place as described below. After completion of the roasting process, the roasted vegetable bulk material 16 is fed into the cooling arrangement 14 and in particular into the cooling chamber 30. A bulk material receiving surface 26 is in this case configured for the coffee beans 16, wherein this bulk material receiving surface 26 is continuously monitored by the thermographic camera 42. Different limit temperatures are set for different cooling durations in the control device 19. The temperature limit in the first 30 seconds of the cooling process is thus 200° C. The temperature limit is thereafter 150° C. If one of these temperature limits is exceeded for at least 3 seconds during the respective cooling duration, a signal is issued in the form of an alarm indicating a local overheating which is possibly caused by a glowing hot spot. The video recorded by the thermographic camera 42 during the cooling process is stored and assigned to the cooling process of the respective roasted batch so that a separate quality check of this batch can again be performed. The recorded video is overwritten if the cooling process runs without an alarm. The control device 19 can also, for example, mark the cooling processes differently based on the duration by which the respective temperature limit is exceeded, wherein these markings are then assigned different priorities, and wherein only the first priority stage triggers an alarm function, which then, for example, also triggers directly for the roasting arrangement 2. This alarm is not triggered at a second priority stage and the operator is only advised to carry out a quality check of the roasted batch.

The present invention is not limited to embodiments described herein; reference should be had to the appended claims.

### LIST OF REFERENCE NUMERALS

2 Roasting arrangement
4 Housing arrangement
6 Roasting device
8 Heating device
10 Interior space
12 Exhaust gas cleaning device
14 Cooling arrangement
16 Bulk material (roasted coffee beans, unroasted coffee beans)
18 Hopper inlet
19 Control device
20 Cooling device
22 Cooling sieve
24 Outlet opening
26 Bulk material receiving surface
28 Hood arrangement
30 Cooling chamber
31 Cold air device
32 First housing part/Dome part
34 Second housing part
36 Bulk material outlet arrangement
38 Air discharge device
40 Sensor arrangement
42 Thermographic camera/Temperature sensor
43 Circulating device
44 Mounting plate
46 Opening
48 Air device
50 Camera lens
52 Arrow

What is claimed is:

1-17. (canceled)

18. A cooling arrangement for a roasted vegetable bulk material, the cooling arrangement comprising:
a cooling chamber for cooling the roasted vegetable bulk material, the cooling chamber comprising,
a bulk material receiving surface, and
a sensor arrangement comprising at least one temperature sensor which is configured to monitor a temperature of the roasted vegetable bulk material.

19. The cooling arrangement as recited in claim 18, wherein the at least one temperature sensor is a thermographic camera.

20. The cooling arrangement as recited in claim 19, wherein the thermographic camera comprises a purge air device.

21. The cooling arrangement as recited in claim 19, wherein,
the thermographic camera comprises a camera lens, and
the cooling chamber further comprises a protective spacer sleeve which is arranged in front of the camera lens of the thermographic camera.

22. The cooling arrangement as recited in claim 21, wherein,
the cooling chamber further comprises a hood arrangement which is arranged above the bulk material receiving surface, and
the at least one temperature sensor is integrated in the hood arrangement.

23. The cooling arrangement as recited in claim 22, wherein,
the cooling chamber further comprises a cooling device,
the thermographic camera is arranged on a side of the hood arrangement which faces away from the cooling device, and
the protective spacer sleeve extends into the cooling chamber.

24. The cooling arrangement according claim 18, further comprising:
a control device which is configured to monitor a cooling process of the cooling arrangement.

25. The cooling arrangement as recited in claim 18, wherein the cooling chamber further comprises a cooling sieve which is configured to receive the roasted vegetable bulk material and to allow for a passage of cold air.

26. The cooling arrangement as recited in claim 18, further comprising:
a circulating device which is configured to have a tangential basic direction for the roasted vegetable bulk material.

27. The cooling arrangement as recited in claim 26, wherein the at least one temperature sensor is configured to monitor only a partial area of the bulk material receiving surface.

28. The cooling arrangement as recited in claim 18, wherein,
the at least one temperature sensor is movably supported,
the cooling chamber further comprises a driving device, and
the at least one temperature sensor is further configured to be drivable by the driving device so that the at least one temperature sensor can monitor different partial areas of the bulk material receiving surface.

29. A roasting arrangement for vegetable bulk material, the roasting arrangement comprising:
the cooling arrangement as recited in claim 18;
a housing arrangement comprising a roasting device which comprises at least one outlet opening;
a heating device which is configured to heat an interior of the roasting device;
an exhaust gas cleaning device which is configured to discharge exhaust gases from the roasting device; and
a control device for monitoring a cooling process,
wherein,
the cooling arrangement is arranged in a region of the at least one outlet opening of the roasting device.

30. A method of operating the roasting arrangement as recited in claim 29, the method comprising:
completing a roasting process so as to obtain roasted vegetables bulk material;
directing the roasted vegetable bulk material into the cooling arrangement so that the roasted vegetable bulk material comprises the bulk material receiving surface;
monitoring the bulk material receiving surface via the at least one temperature sensor; and
outputting a signal via the control device in the event of a local overheating.

31. The method as recited in claim 30, further comprising:
setting different temperature limits for different cooling durations.

32. The method as recited in claim 30, wherein,
a thermographic camera is provided as the at least one temperature sensor, and
after a completion of each roasting process, the process further comprises,
saving the cooling process, via the control device, in a data storage or in a database,
associating a video of the thermographic camera with the cooling process, and
saving the video and marking the cooling process when a preset temperature limit is exceeded.

33. The method as recited in claim 32, wherein the marking is performed based on different priority stages comprising at least a first priority stage and a second priority stage.

34. The method as recited in claim 33, wherein the first priority stage triggers an alarm function.
